(19) United States
(12) Patent Application Publication
(10) Pub. No.: US 2018/0186302 A1
(43) Pub. Date: Jul. 5, 2018

(54) Angular Audio Accessory

(71) Applicants: Robert Maynard, Fernandina Beach, FL (US); Dirk Smith, Raleigh, NC (US); Jacob Edwards, Cary, NC (US)

(72) Inventors: Robert Maynard, Fernandina Beach, FL (US); Dirk Smith, Raleigh, NC (US); Jacob Edwards, Cary, NC (US)

(21) Appl. No.: 15/862,518

(22) Filed: Jan. 4, 2018

Related U.S. Application Data
(60) Provisional application No. 62/442,292, filed on Jan. 4, 2017.

(51) Int. Cl. B60R 11/02; H04R 1/02

(52) U.S. Cl. CPC B60R 11/0217; H04R 2499/13; H04R 1/02

(57) ABSTRACT

An angular audio accessory for redirecting a speaker bar consists of a stationary U-channel, a collapsible U-channel, a hinging mechanism, and a clamping mechanism. The collapsible U-channel is hingedly connected to the stationary U-channel with the hinging mechanism. The configuration of the collapsible U-channel is determined with the clamping mechanism. When in use, the stationary U-channel is attached to a body of a vehicle. The speaker bar that needs to be redirected is connected to the collapsible U-channel. Thus, the speaker bar can be positioned in parallel to the stationary U-channel or perpendicular to the stationary U-channel.

The current application claims a priority to the U.S. Provisional Patent application Ser. No. 62/442,292 filed on Jan. 4, 2017.

### FIELD OF THE INVENTION

The present invention relates generally to a hinging mechanism. More specifically, the present invention is an apparatus that helps a speaker to be positioned at a different angle from the original position. Thus, the overall sound from the speaker is redirected. Moreover, any sound wave reflections and sound degradation due to the original orientation is eliminated.

### BACKGROUND OF THE INVENTION

Off-road vehicles are used in a variety of outdoor activities such as camping, fishing, and tailgating. Certain modifications are made based upon the activity the off-road vehicle is used for. Retracting the roof and removing the doors are some of the most common modifications that are executed without any major changes to the overall design of the off-road vehicle. A variety of other modifications such as repositioning the speaker bar requires the user to make significant changes to the overall design of the off-road vehicle.

Generally, in a vehicle with a retractable roof, the speaker bar is positioned parallel to the floor and oriented towards the floor. The original positioning of the speaker bar is useful when the passengers are seated inside the vehicle. However, when the users are outside the vehicle, the sound from the speaker bar is degraded when reaching the users. Therefore, a convenient method to reposition the speaker bar is clearly required.

When considering the speaker bar of a Jeep Wrangler, the speaker bar is permanently mounted parallel to the floor and oriented towards the floor. Different mounts can be installed to permanently reposition the speaker bar at an angle. As an example, the speaker bar can be positioned at a 60-degree angle from the original position using an external mount which would be a permanent fixture. However, if the speaker bar needs to be repositioned, the external mount needs to be removed and the speaker has to be rewired. The time-consuming process of installing and uninstalling can be stressful to the user.

The objective of the present invention is to address the aforementioned issues. In particular, the present invention introduces an apparatus that allows the speaker to be conveniently repositioned, so that the output from the speaker is redirected. By utilizing the present invention, the speaker is repositioned at a 90-degree angle from the original position. When the user is in the vehicle, the speaker bar is placed in the original position so that the speaker is directed towards the floor of the vehicle. As discussed before, in the preferred embodiment, the present invention is designed to be used with a Jeep Wrangler. However, other embodiments of the present invention can be designed to be used with different off-road vehicles.

### BRIEF DESCRIPTION OF THE DRAWINGS

FIG. 1A is a perspective view of the present invention, wherein the present invention is in a deployed configuration.

FIG. 1B is a perspective view of the present invention, wherein the present invention is in a stored configuration.

FIG. 2A is a side view of the present invention, wherein the present invention is in a deployed configuration.

FIG. 2B is side view of the present invention, wherein the present invention is in a stored configuration.

FIG. 3 is a perspective exploded view of the present invention, wherein the present invention is in a deployed configuration.

FIG. 4 is a front view of the present invention, wherein the present invention is in a deployed configuration.

FIG. 5 is an illustration of the present invention in use, wherein the present invention is in the stored configuration.

FIG. 6 is an illustration of the present invention in use, wherein the present invention is in the deployed configuration.

### DETAIL DESCRIPTIONS OF THE INVENTION

All illustrations of the drawings are for the purpose of describing selected versions of the present invention and are not intended to limit the scope of the present invention.

The present invention introduces an accessory that allows a speaker bar to rotate 90-degrees from the original positioning. The effective design of the present invention allows the user to have the speaker bar at multiple positions without making any significant changes to the vehicle. Thus, the sound emitted from the speaker bar can be redirected as desired.

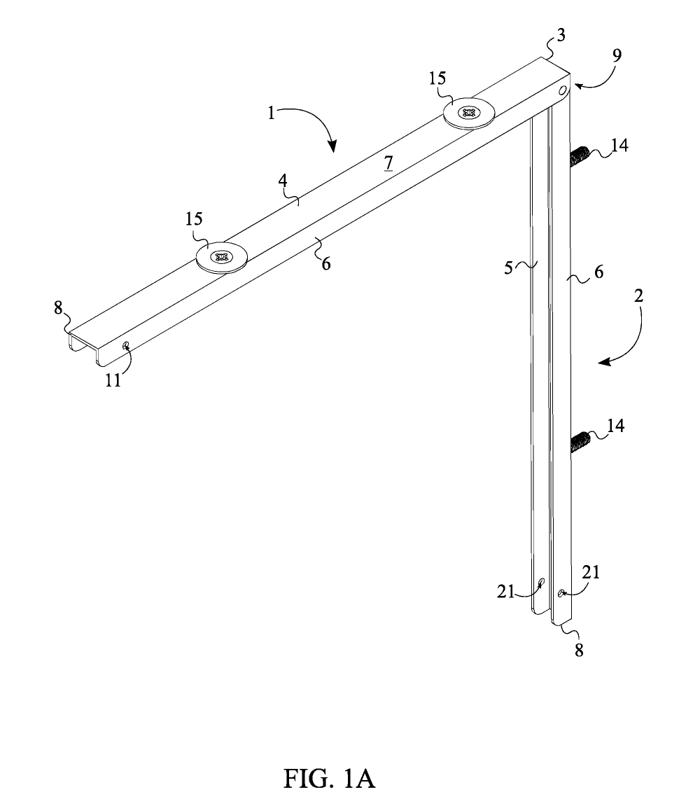

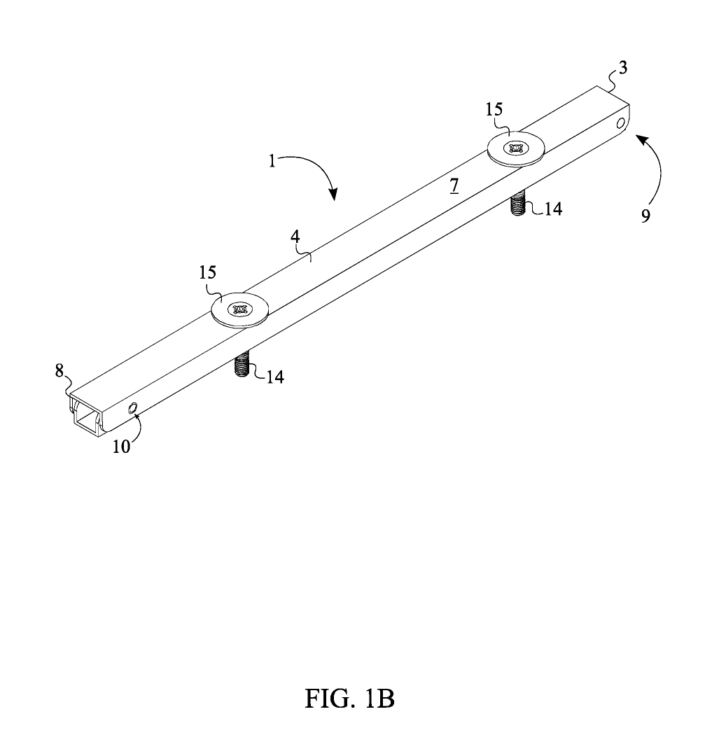

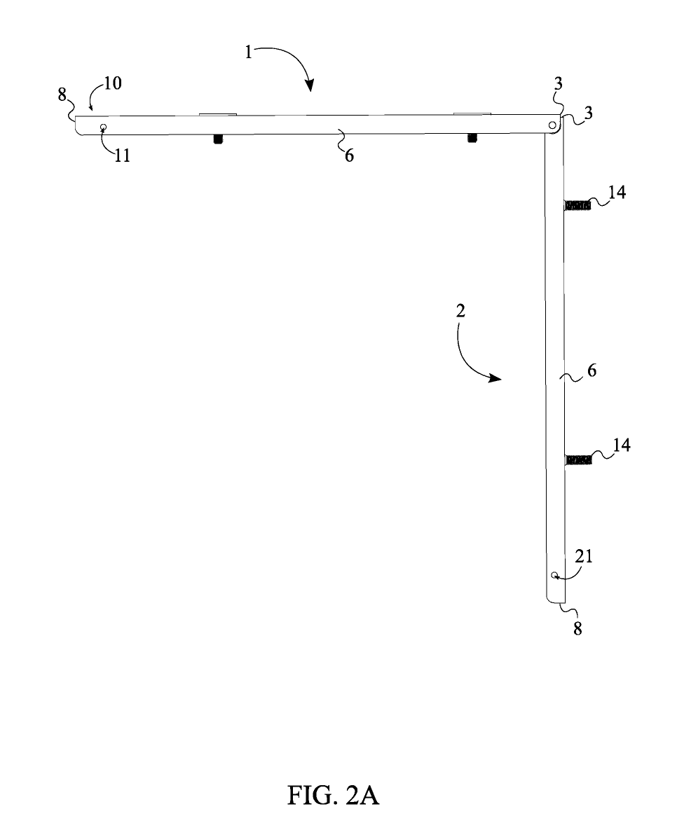

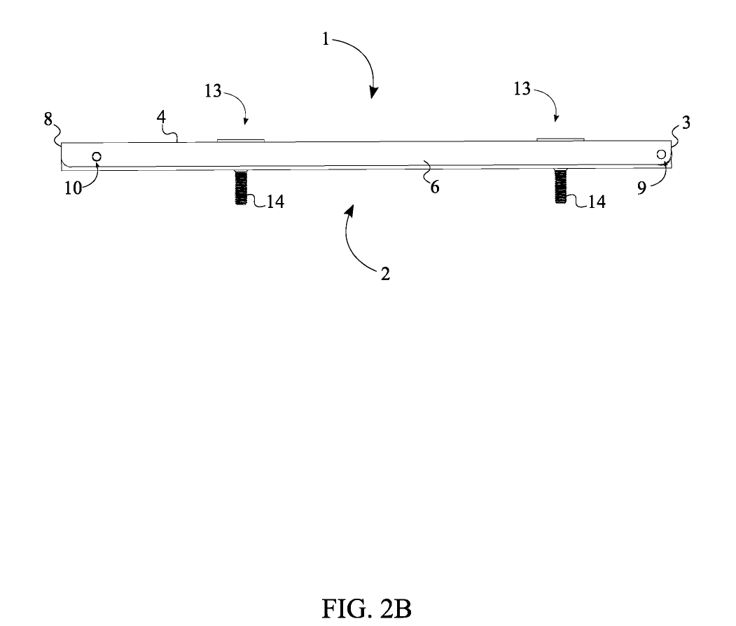

As seen in FIGS. 1A-3, to redirect the speaker bar as desired, the present invention comprises a stationary U-channel 1, a collapsible U-channel 2, a hinging mechanism 9, and a clamping mechanism 10. When used with an off-road vehicle, the present invention establishes a connection with the off-road vehicle through the stationary U-channel 1. The collapsible U-channel 2 is terminally and hingedly connected to the stationary U-channel 1 with the hinging mechanism 9 which can vary in different embodiments of the present invention. The hinging mechanism 9 allows the user to position the collapsible U-channel 2 in a deployed configuration or in a stored configuration as preferred. As shown in FIG. 1A and FIG. 2A, in the deployed configuration, the collapsible U-channel 2 is positioned perpendicular to the stationary U-channel 1. As shown in FIG. 1B and FIG. 2B, in the stored configuration, the collapsible U-channel 2 is removably affixed within the stationary U-channel 1 with the clamping mechanism 10 that can vary in different embodiments of the present invention. The speaker bar the present invention is used with is mounted onto the collapsible U-channel 2. Thus, the speaker bar can also be positioned in the collapsible configuration or the stored configuration. More specifically, in the deployed configuration, the speaker bar is positioned perpendicular to the stationary U-channel 1. On the other hand, in the stored configuration, the speaker bar is positioned parallel to the floor.

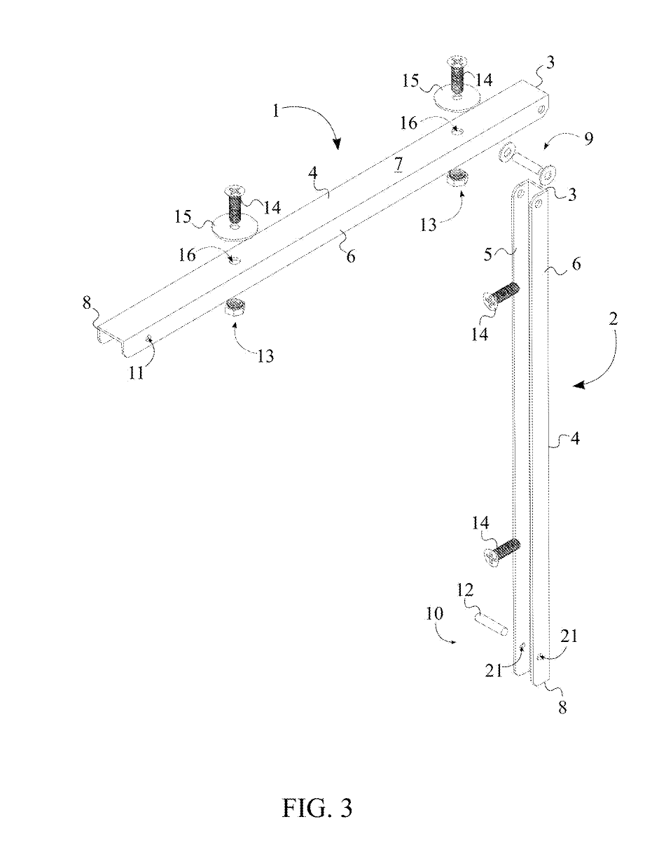

To accommodate the deployed configuration and the stored configuration, the stationary U-channel 1 and the collapsible U-channel 2 each comprise a first end 3, a body 4, and a second end 8. As seen in FIG. 3, the body 4 extends from the first end 3 to the second end 8 and determines an overall length of the stationary U-channel 1 and the collapsible U-channel 2. In the preferred embodiment, the length of the stationary U-channel 1 and the length of the collapsible U-channel 2 is designed for the present invention to be used with a Jeep Wrangler. However, in other embodiments, the stationary U-channel 1 and the collapsible U-channel 2 can be designed differently to be used with other off-road vehicles.

As discussed before, the collapsible U-channel 2 is hingedly connected to the stationary U-channel 1. More specifically, the first end 3 of the collapsible U-channel 2 is hingedly connected to the first end 3 of the stationary U-channel 1 allowing the deployed configuration and the stored configuration. To be in the stored configuration, the body 4 of the stationary U-channel 1 is designed such that the body 4 of the collapsible U-channel 2 can be sleeved by the body 4 of the stationary U-channel 1. In other words, the collapsible U-channel 2 is positioned within the stationary U-channel 1 in the stored configuration as seen in FIG. 1B.

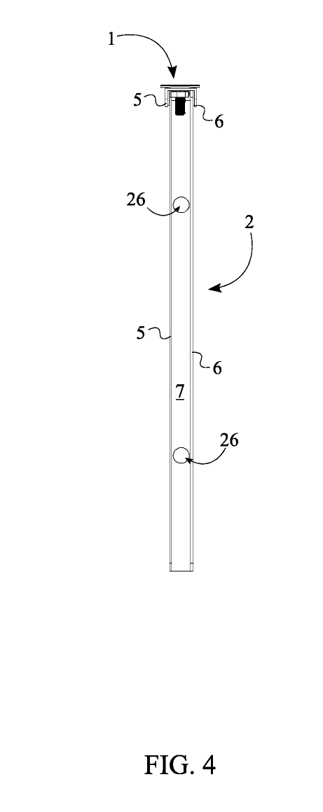

As shown in FIG. 3 and FIG. 4, to create the U-shape, the stationary U-channel 1 and the collapsible U-channel 2 each comprise a first lateral wall 5, a base section 7, and a second lateral wall 6. The first lateral wall 5 is terminally and perpendicularly connected to the base section 7. The second lateral wall 6 is terminally and perpendicularly connected to the base section 7 opposite to the first lateral wall 5 across the base section 7. Thus, a distance between the first lateral wall 5 and the second lateral wall 6 determines a width of the base section 7. To position the collapsible U-channel 2 within the stationary U-channel 1, a width of the base section 7 of the stationary U-channel 1 is greater than a width of the base section 7 of the collapsible U-channel 2.

As mentioned earlier, the clamping mechanism 10, which can vary in different embodiments of the present invention, is used to position the collapsible U-channel 2 within the stationary U-channel 1. As seen in FIG. 3, in the preferred embodiment of the present invention, the clamping mechanism 10 comprises a quick release pin 12, a first pin-receiving hole 11, and a second pin-receiving hole 21. However, the clamping mechanism 10 can be different in other embodiments of the present invention. The first pin-receiving hole 11 traverses through the first lateral wall 5 and the second lateral wall 6 adjacent to the second end 8 of the stationary U-channel 1. Similarly, the second pin-receiving hole 21 traverses through the first lateral wall 5 and the second lateral wall 6 adjacent to the second end of the collapsible U-channel 2. When the collapsible U-channel 2 is in the stored configuration, the quick release pin 12 is positioned into the first pin-receiving hole 11 and the second pin-receiving hole 21. To be in the stored configuration, the first pin-receiving hole 11 is concentrically aligned with the second pin-receiving hole 21. When the collapsible U-channel 2 needs to be in the deployed configuration, the quick release pin 12 is removed from the first pin-receiving hole 11 and the second pin-receiving hole 21.

Preferably, the quick release pin 12 comprises a lanyard and an insert portion, wherein the lanyard is connected to the insert portion. The lanyard is used to keep the quick release pin 12 attached to the present invention. On the other hand, the insert portion is used to secure the collapsible U-channel 2 within the stationary U-channel 1 by being positioned into the first pin-receiving hole 11 and the second pin-receiving hole 21.

As mentioned before, the stationary U-channel 1 is secured against a body of the off-road vehicle. On the other hand, the speaker bar is mounted onto the collapsible U-channel 2. As seen in FIGS. 1A-4, the present invention further comprises a fastening mechanism 13 that is integrated along the body 4 of the stationary U-channel 1 and the body 4 of the collapsible U-channel 2. The fastening mechanism 13, that is integrated in between the first end 3 and the second end 8, can vary in different embodiments of the present invention. In the preferred embodiment, the fastening mechanism 13 comprises a plurality of screws 14, a plurality of washers 15, a first plurality of screw-receiving holes 16, and a second plurality of screw-receiving holes 26. The first plurality of screw-receiving holes 16 traverses through the base section 7 of the stationary U-channel 1. On the other hand, the second plurality of screw-receiving holes 26 traverses through the base section 7 of the collapsible U-channel 2. The plurality of washers 15 is initially pressed against the first plurality of screw-receiving holes 16 and the second plurality of screw-receiving holes 26. Next, the plurality of screws 14 is removably positioned into the first plurality of screw-receiving holes 16 and the second plurality of screw-receiving holes 26. Thus, the stationary U-channel 1 is attached to the body of the off-road vehicle. On the other hand, the speaker bar is mounted onto the collapsible U-channel 2.

In the preferred embodiment, when the present invention is being used with a Jeep Wrangler, the following process flow is generally followed. Initially, the speaker bar is removed by unfastening the screws. To detach the speaker bar from the internal wiring, the wiring harness is disconnected from the speaker bar. After the speaker bar is removed a roll-bar cover is rolled away exposing a Styrofoam section encircling the roll-bar. To position the stationary U-channel 1 into the position of the speaker bar, a section of the Styrofoam section is trimmed. When the present invention is offered for use, a template will be provided to trim the Styrofoam. If the template is not provided, the stationary U-channel 1 can be positioned against the roll-bar to determine the amount that needs to be trimmed off the Styrofoam. When trimming the Styrofoam is complete, the wires that connect to the speaker are rearranged along an interior surface of the roll-bar. The process is executed for both the left side of the vehicle and the right side of the vehicle.

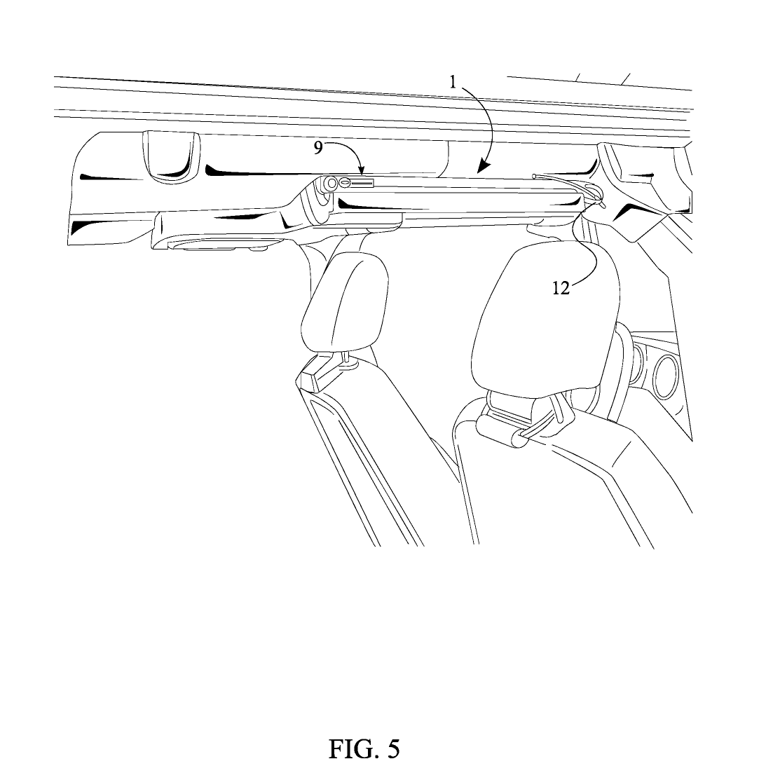

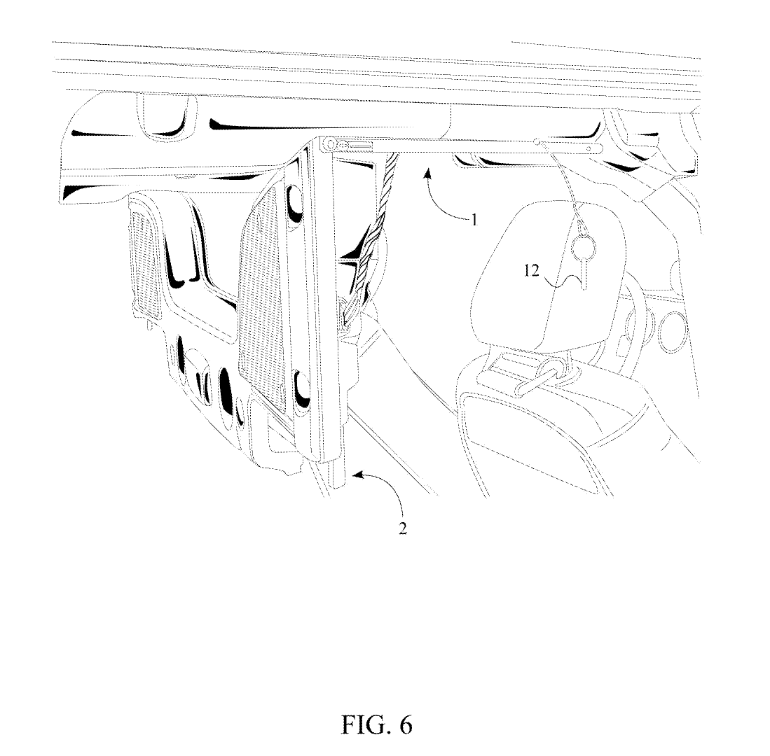

Next, the speaker bar that was previously removed is mounted onto the collapsible U-channel 2 through the fastening mechanism 13. More specifically, the speaker bar is pressed against the base section 7 of the collapsible U-channel 2 opposite to the first lateral wall 5 and the second lateral wall 6. When the speaker bar is mounted, the assembly that contains the present invention and the speaker bar is mounted onto the roll-bar of the vehicle. To do so, the stationary U-channel 1 is connected to the roll-bar through the fastening mechanism 13. Next, the wiring harness is connected to the speaker bar so that the electrical circuit is complete. When the stationary U-channel 1 is connected to the roll-bar, the collapsible U-channel 2 and the attached speaker bar can be positioned in the stored configuration with the clamping mechanism 10 as shown in FIG. 5. More specifically, the quick release pin 12 is positioned into the first pin-receiving hole 11 and the second pin-receiving hole 21 so that the body 4 of the collapsible U-channel 2 is positioned within the body 4 of the stationary U-channel 1. Thus, the speaker bar will be in the original position. When needed, the quick release pin 12 is removed so that the present invention is in the deployed configuration as shown in FIG. 6. The process is executed for both the left side of the vehicle and the right side of the off-road vehicle.

Although the invention has been explained in relation to its preferred embodiment, it is to be understood that many other possible modifications and variations can be made without departing from the spirit and scope of the invention as hereinafter claimed.

What is claimed is:

1. An angular audio accessory comprises:
a stationary U-channel;
a collapsible U-channel;
a hinging mechanism;
a clamping mechanism;
the collapsible U-channel being terminally and hingedly connected to the stationary U-channel through the hinging mechanism;
the collapsible U-channel being positioned perpendicular to the stationary U-channel, wherein the collapsible U-channel is in a deployed configuration; and
the collapsible U-channel being removably affixed within the stationary U-channel with the clamping mechanism, wherein the collapsible U-channel is in a stored configuration.

2. The angular audio accessory as claimed in claim 1 further comprises:
the stationary U-channel and the collapsible U-channel each comprise a first end, a body, and a second end; and
the body extending from the first end to the second end.

3. The angular audio accessory as claimed in claim 2 further comprises:
the first end of the collapsible U-channel being hingedly connected to the first end of the stationary U-channel; and
the body of the collapsible U-channel being sleeved by the body of the stationary U-channel, wherein the collapsible U-channel is in the stored configuration.

4. The angular audio accessory as claimed in claim 1 further comprises:
the stationary U-channel and the collapsible U-channel each comprise a first lateral wall, a base section, and a second lateral wall;
the first lateral wall being terminally and perpendicularly connected to the base section; and
the second lateral wall being terminally and perpendicularly connected to the base section opposite to the first lateral wall.

5. The angular audio accessory as claimed in claim 2 further comprises:
the clamping mechanism comprises a quick release pin, a first pin-receiving hole, and a second pin-receiving hole;
the first pin-receiving hole traversing through a first lateral wall and a second lateral wall of the stationary U-channel adjacent to the second end;
the second pin-receiving hole traversing through a first lateral wall and a second lateral wall of the collapsible U-channel adjacent to the second end;
the first pin-receiving hole being concentrically aligned with the second pin-receiving hole, wherein the collapsible U-channel is in the stored configuration; and
the quick release pin being removably positioned into the first pin-receiving hole and the second pin-receiving hole, wherein the collapsible U-channel is in the stored configuration.

6. The angular audio accessory as claimed in claim 1 further comprises:
a fastening mechanism; and
the fastening mechanism being integrated along the body of the stationary U-channel and the body of the collapsible U-channel; and
the fastening mechanism being integrated in between the first end and the second end of both the stationary U-channel and the collapsible U-channel.

7. The angular audio accessory as claimed in claim 6 further comprises:
the fastening mechanism comprises a plurality of screws, a plurality of washers, a first plurality of screw-receiving holes, and a second plurality of screw-receiving holes;
the first plurality of screw-receiving holes traversing through a base section of the stationary U-channel;
the second plurality of screw-receiving holes traversing through a base section of the collapsible U-channel;
the plurality of washers being pressed against the first plurality of screw-receiving holes and the second plurality of screw-receiving holes; and
the plurality of screws being removably positioned into the first plurality of screw-receiving holes and the second plurality of screw-receiving holes through the plurality of washers.
